(19) United States
(12) Patent Application Publication
(10) Pub. No.: US 2015/0006551 A1
(43) Pub. Date: Jan. 1, 2015

(54) Method, Apparatus And Mobile Terminal For Processing Contacts

(71) Applicant: TENCENT TECHNOLOGY (SHENZHEN) COMPANY LIMITED, Shenzhen City (CN)

(72) Inventors: Qing WANG, Shenzhen (CN); Zhanghu LUO, Shenzhen City (CN); Zefeng HUANG, Shenzhen City (CN); Haoran GUO, Shenzhen City (CN); Quanhao XIAO, Shenzhen City (CN); Yixia YUAN, Shenzhen City (CN); Jiashun SONG, Shenzhen City (CN); Pengtao LI, Shenzhen City (CN); Yunfeng DAI, Shenzhen City (CN)

(21) Appl. No.: 14/462,626

(22) Filed: Aug. 19, 2014

Related U.S. Application Data
(63) Continuation of application No. PCT/CN2013/072051, filed on Mar. 1, 2013.

(30) Foreign Application Priority Data
Mar. 1, 2012 (CN) 201210052084.4

(51) Int. Cl. G06F 17/30

(52) U.S. Cl. CPC G06F 17/30595
USPC 707/752

(57) ABSTRACT

A predefined sorting policy includes at least two sorting rules. Each one of at least two sorting rules is a static sorting rule or a dynamic sorting rule and is configured with a priority. Contact information is obtained according to the predefined sorting policy, wherein the contact information includes dynamic information and/or static information. Applying an order of the at least two sorting rules is determined in a descending order of priorities of the at least two sorting rules. The contacts are sorted according to the at least two sorting rules in turn based on the obtained contact information.

### CROSS-REFERENCE TO RELATED APPLICATIONS

This application is a continuation of International Patent Application No. PCT/CN2013/072051, filed on Mar. 1, 2013. This application claims the benefit and priority of Chinese Patent Application No. 201210052084.4 filed Mar. 1, 2012. The entire disclosures of each of the above applications are incorporated herein by reference.

### FIELD

The present disclosure relates to mobile terminal changes and, more particularly, to a method, an apparatus and a mobile terminal for processing contacts.

### BACKGROUND

This section provides background information related to the present disclosure which is not necessarily prior art.

A Mobile terminal is an important communication tool in people's daily lives. It has become an important communication bridge between relatives, friends, schoolmates, colleagues, and customers. Usually, a lot of contacts are saved in the mobile terminal.

In an existing technique, contacts in the mobile terminal are sorted by a fixed rule, e.g., by Pinyin of names (or first letters) of the contacts. When the user searches for a contact, the contacts are traversed. The user may also input a searching condition, e.g., a first letter of a family name. The mobile terminal displays contacts matching with the searching condition. Thus, the contact may be found rapidly.

### SUMMARY

This section provides a general summary of the disclosure, and is not a comprehensive disclosure of its full scope or all of its features.

Various embodiments of the present disclosure provide a method, an apparatus and a mobile terminal for processing contacts, so as to reduce time for finding a contact, increase information processing performance of the mobile terminal, and increase intelligence degree of the mobile terminal.

According to various embodiments of the present disclosure, a method for processing contacts is provided. The method includes the following:

obtaining a predefined sorting policy, wherein the predefined sorting policy comprises at least two sorting rules; each one of at least two sorting rules is a static sorting rule or a dynamic sorting rule and is configured with a priority;

obtaining contact information according to the predefined sorting policy, wherein the contact information includes dynamic information and/or static information; and

determining an applying order of the at least two sorting rules in a descending order of priorities of the at least two sorting rules;

sorting the contacts according to the at least two sorting rules in turn based on the obtained contact information;

wherein a sorted result is obtained after the contacts are sorted according to a prior sorting rule of the at least two sorting rules, and the sorted result is sorted according to a posterior sorting rule of the at least two sorting rules.

According to various embodiments of the present disclosure, an apparatus for processing contacts is provided. The apparatus includes the following:

one or more processors;

a memory; and

one or more program modules stored in the memory and to be executed by the one or more processors; the one or more program modules comprise the following:

a first obtaining module, adapted to obtain a predefined sorting policy, wherein the predefined sorting policy comprises at least two sorting rules, each one of the at least sorting rules is a static sorting rule or a dynamic sorting rule;

a priority configuring module, adapted to respectively configure a priority for each of the at least two sorting rules;

a second obtaining module, adapted to obtain contact information according to the predefined sorting policy obtained by the first obtaining module, wherein the contact information comprises dynamic information and/or static information; and

a sorting module, adapted to determine an applying order of the at least two sorting rules according to a descending order of priorities of the at least two sorting rules, sort contacts according to the at least two sorting rules obtained by the first obtaining module in turn based on the contact information obtained by the second obtaining module;

wherein a sorted result is obtained after the contacts are sorted according to a prior sorting rule of the at least two sorting rules, and the sorted result is sorted according to a posterior sorting rule of the at least two sorting rules.

According to various embodiments of the present disclosure, a mobile terminal for processing contacts is provided. The terminal includes the apparatus for processing contacts as described above.

The technical solution provided by the present disclosure brings out the following advantages.

A predefined sorting policy is obtained and contact information is obtained according to the sorting policy. According to the obtained contact information, the contacts are sorted following the sorting policy. Since the predefined sorting policy includes at least one of a static sorting rule and a dynamic sorting rule, it is possible to find a contact according to multiple sorting rules, which facilitates the user to find the contact rapidly, reduces time for finding the contact, increases the information processing performance of the mobile terminal, and increases the intelligence degree of the mobile terminal.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

Figures used in the descriptions of the following various embodiments or existing techniques are briefly introduced herein to make the technical solution of the present disclosure clearer. It should be noted that the following figures are merely examples. Those skilled in the art would get many variations according to these figures without an inventive work.

FIG. 1 is a flowchart illustrating a method for processing contacts according to various embodiments of the present disclosure.

FIG. 2 is a flowchart illustrating a method for processing contacts according to a various embodiments of the present disclosure.

FIG. 3 is a diagram illustrating an apparatus for processing contacts according to various embodiments of the present disclosure.

FIG. 4 is a diagram illustrating an apparatus for processing contacts according to various embodiments of the present disclosure.

Corresponding reference numerals indicate corresponding parts throughout the several views of the drawings.

### DETAILED DESCRIPTION

Example embodiments will now be described more fully with reference to the accompanying drawings.

The present disclosure is described in further detail hereinafter with reference to accompanying drawings and examples to make the technical solution and merits therein clearer.

According to various embodiments, a method for processing contacts is shown in FIG. 1, and the method includes the following.

At block 101, a predefined sorting policy is obtained, wherein the predefined sorting policy includes at least one of a static sorting rule and a dynamic sorting rule. The static sorting rule includes at least one of the following: a sorting-by-name rule, a sorting-by-number rule, a sorting-by-subscribed location rule, a sorting-by-operator rule, a sorting-by-contact relationship rule, and a sorting-by-mailbox rule. The dynamic sorting rule includes at least one of the following: a sorting-by-communication time rule, a sorting-by-communication frequency rule, a sorting-by-communication duration rule, and a sorting-by-IM focus degree rule. The sorting-by-communication frequency rule may include a sorting-by-outgoing times rule, a sorting-by-incoming times rule, a sorting-by-number of calls rule, a sorting-by-number of short messages rule, and a sorting-by-communication times rule.

At block 102, contact information is obtained according to the predefined sorting policy, wherein the contact information includes dynamic information and/or static information. The static information of the contact includes any one or any combination of: name, number, number subscribed location, operator that the number belongs to, contact group. The dynamic information of the contact includes any one or any combination of: number of calls, call duration, number of short messages, IM times, and number of mails.

At block 103, based on the obtained contact information, the contacts are sorted by the predefined sorting policy.

According to various embodiments, a predefined sorting policy is obtained and contact information is obtained according to the sorting policy. According to the obtained contact information, the contacts are sorted according to the sorting policy. Since the predefined sorting policy includes at least one of a static sorting rule and a dynamic sorting rule, it is possible to find a contact according to multiple sorting rules, which facilitates the user to find the contact rapidly, reduces time for finding the contact, increases the information processing performance of the mobile terminal, and increases the intelligence degree of the mobile terminal.

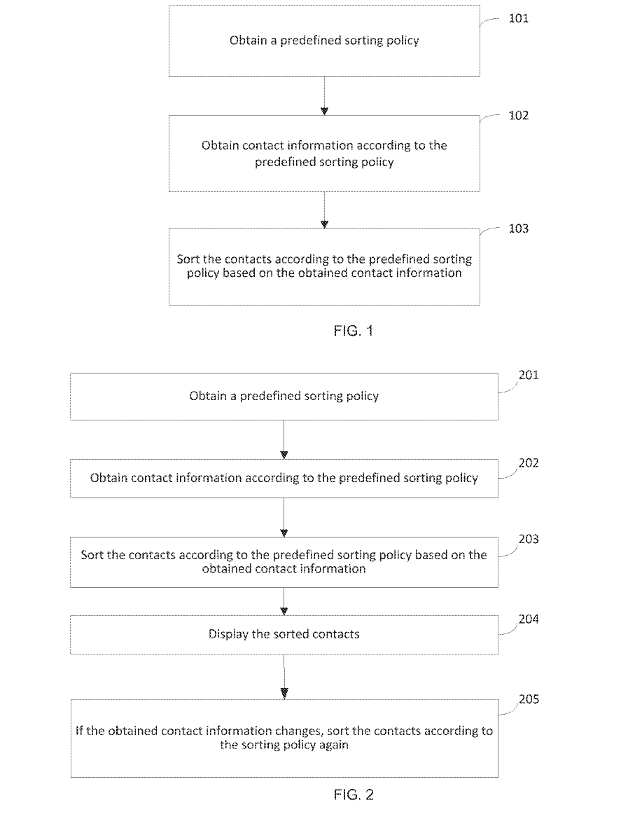

According to various embodiments, a method for processing contacts is shown in FIG. 2, and the method includes the following.

At block 201, a predefined sorting policy is obtained, wherein the predefined sorting policy includes at least one of a static sorting rule and a dynamic sorting rule. In particular, the static sorting rule includes at least one of the following: a sorting-by-name rule, a sorting-by-number rule, a sorting-by-subscribed location rule, a sorting-by-operator rule, a sorting-by-contact relationship rule, and a sorting-by-mailbox rule. The dynamic sorting rule includes at least one of the following: a sorting-by-communication time rule, a sorting-by-communication frequency rule, a sorting-by-communication duration rule, a sorting-by-IM focus degree rule. The sorting-by-communication frequency rule may include a sorting-by-outgoing times rule, a sorting-by-incoming times rule, a sorting-by-number of calls rule, a sorting-by-number of short messages rule, and a sorting-by-communication times rule.

The sorting rules may be stored in the mobile terminal. If the predefined sorting policy includes at least two kinds of sorting rules, the method further includes a process of configuring priorities for the at least two sorting rules after this block.

The sorting policy may be configured in the mobile terminal in advance. For example, a default sorting policy 1 may be configured in the mobile terminal: a combination of sorting-by-name rule and sorting-by-operator rule (the priority of the sorting-by-name rule is 1, the priority of the sorting-by-operator rule is 2), a sorting policy 2: a combination of sorting-by-name rule and a number of short messages sorting policy. The sorting policy may also be configured by the user according to a practical requirement.

At block 202, contact information is obtained according to the predefined sorting policy, wherein the contact information includes dynamic information and/or static information. The static information of the contact includes at least one of: name, number, number subscribed location, operator that the number belongs to, and contact group. The dynamic information of the contact includes at least one of: number of calls, call duration, number of short messages, IM times, and number of mails.

The static information may be obtained using at least two approaches. In a first approach, a static information summary table (as shown in Table 1) is configured in the mobile terminal. The static information corresponding to the sorting policy is obtained directly from the static information summary table. The static information summary table includes various kinds of static information of the contacts. Table 1 shows a static information summary table generated according to an order that contacts are added by the user. The static information in this static information summary table is merely an example. The present disclosure is not limited to approach.

TABLE 1
Static Information Summary Table

| | Number | Subscribed | | |
|---|---|---|---|---|
| Name | Range | Location | Operator | Contact Group |
| A1 | 130 | GUANGZHOU | China Unicom | schoolmates |
| B2 | 136 | SHENZHEN | China Mobile | schoolmates |
| C3 | 133 | SHENZHEN | China | schoolmates |
| | | | Telecommunications | |
| B3 | 133 | SHENZHEN | China | friends |
| | | | Telecommunications | |
| A3 | 136 | GUANGZHOU | China Mobile | colleagues |
| A2 | 159 | CHONGQING | China Mobile | relatives |
| C1 | 139 | BEIJING | China Mobile | relatives |
| B1 | 130 | BEIJING | China Unicom | colleagues |
| C2 | 159 | BEIJING | China Mobile | friends |
| A5 | 136 | DALIAN | China Mobile | friends |
| A4 | 133 | SHENZHEN | China | colleagues |
| | | | Telecommunications | |

Optionally, it is also possible to configure multiple static information tables according to various sorting rules, e.g., a number range information table, a subscribed location information table, etc. (as shown in Table 2). Contact information is obtained from the static information tables corresponding to the sorting rules respectively.

TABLE 2
Subscribed Location Information Table

| Name | Subscribed Location |
|---|---|
| A1 | GUANGZHOU |
| B2 | SHENZHEN |
| C3 | SHENZHEN |
| B3 | SHENZHEN |
| A3 | GUANGZHOU |
| A2 | CHONGQING |
| C1 | BEIJING |
| B1 | BEIJING |
| C2 | BEIJING |
| A5 | DALIAN |
| A4 | SHENZHEN |

In a second approach, the static information of the contact is obtained directly from a local address book according to the predefined sorting policy. As to the obtaining of the dynamic information, in various embodiments, the dynamic information of the contact is obtained from a dynamic information table. In various embodiments, the obtaining of the dynamic information can include:
creating a dynamic information table, and updating the dynamic information of contacts in the dynamic information table in real time; and
obtaining the dynamic information of the contacts from the dynamic information table according to the dynamic sorting rule.

In various embodiments, the dynamic information table may be as shown in Table 3 and Table 4. Table 3 shows a recent dynamic information table recorded by the mobile terminal. This table records communication times and communication duration of each contact within one week. Table 4 is a history dynamic information table recorded by the mobile terminal. This table records all communication times and communication duration of each contact. When a communication event happens, the communication times and communication duration in the dynamic information table are updated according to a type of the communication event. For example, if the user sends a short message to a contact, the number of short messages of this contact in the corresponding dynamic information table is added by 1.

Table 3 may further include one kind of dynamic information, i.e., weighted information. Value of the weighted information=2*outgoing times+1* incoming times. If the sorting policy obtained in block 201 is a sorting-by-weighted dynamic information policy, the dynamic information obtained according to the sorting policy is the weighted information.

TABLE 3
Recent Dynamic Information Table

| | | | | | | Call |
|---|---|---|---|---|---|---|
| | Outgoing | Incoming | Number | Short | Communica- | Dura- |
| Name | Times | Times | of Calls | Message | tion Times | tion |
| A1 | 2 | 5 | 7 | 3 | 10 | 2.6 |
| B2 | 4 | 6 | 10 | 8 | 18 | 0.9 |
| C3 | 7 | 7 | 14 | 6 | 20 | 1.5 |
| B3 | 3 | 1 | 4 | 5 | 9 | 6.5 |
| A3 | 0 | 8 | 8 | 12 | 20 | 0.3 |
| A2 | 6 | 2 | 8 | 7 | 15 | 0.5 |
| C1 | 1 | 3 | 4 | 0 | 4 | 0.5 |
| B1 | 5 | 0 | 5 | 1 | 6 | 0.8 |
| C2 | 0 | 0 | 0 | 0 | 0 | 0 |
| A5 | 2 | 5 | 7 | 2 | 9 | 1.5 |
| A4 | 9 | 4 | 13 | 2 | 15 | 1.1 |

TABLE 4
History Dynamic Information Table

| | | | | | | Call |
|---|---|---|---|---|---|---|
| | Outgoing | Incoming | Number | Short | Communica- | Dura- |
| Name | Times | Times | of Calls | Message | tion Times | tion |
| A1 | 21 | 8 | 29 | 13 | 42 | 6.2 |
| B2 | 20 | 13 | 33 | 21 | 54 | 9.1 |
| C3 | 17 | 15 | 32 | 20 | 52 | 3.1 |
| B3 | 4 | 7 | 11 | 33 | 44 | 12.5 |
| A3 | 0 | 17 | 17 | 13 | 30 | 3.4 |
| A2 | 20 | 5 | 25 | 19 | 44 | 3.4 |
| C1 | 10 | 13 | 23 | 7 | 30 | 3.5 |
| B1 | 18 | 1 | 19 | 4 | 23 | 2.3 |
| C2 | 0 | 0 | 0 | 0 | 0 | 0 |
| A5 | 12 | 13 | 25 | 9 | 34 | 6.7 |
| A4 | 31 | 13 | 44 | 14 | 58 | 9.3 |

In various embodiments, an instant messaging information table may be generated according to dynamic information and static information of an instant messaging tool. Accordingly, the mobile terminal may obtain static information and dynamic information related to the instant messaging from this table. The generated instant messaging information table may be as shown in Table 5. The instant messaging tool includes QQ, Fetion, etc.

TABLE 5
Instant Messaging Information Table

| Name | IM Contact Group | Recent Focus Times |
|---|---|---|
| A1 | schoolmates | 1 |
| B2 | N/A | 0 |
| C3 | schoolmates | 10 |
| B3 | friends | 21 |
| A3 | colleagues | 7 |
| A2 | N/A | 0 |
| C1 | N/A | 0 |
| B1 | colleagues | 8 |
| C2 | friends | 14 |
| A5 | friends | 6 |
| A4 | colleagues | 3 |

At block 203, the contacts are sorted according to the predefined sorting policy based on the obtained contact information. In various embodiments, if the obtained predefined sorting policy includes at least two sorting rules and the at least two sorting rules are respectively configured with a priority, block 203 specifically includes the following:
determining an applying order of the sorting rules according to a descending order of the priorities of the sorting rules; according to the determined applying order, sorting the contacts according to the sorting rules in turn;
wherein a sorted result is obtained after the contacts are sorted according to a prior sorting rule, and then the sorted result is sorted according to a posterior sorting rule.

For example, the obtained predefined sorting policy includes a sorting-by-name rule, a sorting-by-number range rule, and a sorting-by-outgoing times rule. The priority of the sorting-by-name rule is 1, the priority of the sorting-by-number range rule is 2, and the priority of the sorting-by-outgoing times rule is 3, wherein the priority of the sorting-by-name rule is the highest. According to a descending order of the priorities, the applying order of the sorting rules is as follows: the sorting-by-name rule, the sorting-by-number range rule, and the sorting-by-outgoing times rule. The contacts are first sorted according to the sorting-by-name rule based on their name information. After the sorting operation based on the name information, if there are contacts having the same name information (e.g., having the same first letter), the contacts with the same name information obtained after the sorting operation according to the sorting-by-name rule are sorted again according to the sorting-by-number range rule based on their number range information. After the sorting operation according to the sorting-by-number range rule, if there are contacts having the same number range information, these contacts are sorted again according to the sorting-by-outgoing times rule based on their outgoing times information.

At block 204, the sorted contacts are displayed. The user may configure a plurality of sorting rules according to a practical scenario requirement. After sorting operations according to the plurality of sorting rules, the user is able to find a required contact rapidly.

At block 205, if the obtained contact information changes, the contacts are sorted again according to the predefined sorting policy. In various embodiments, the re-sorting operation may be performed to all contacts or to some of the contacts, which may be determined according to a priority level of the sorting rule corresponding to the changed contact information.

In addition, if the priority of the sorting rule corresponding to the changed contact information is 1 (i.e., the highest priority) in the predefined sorting policy, all of the contacts are sorted again according to the predefined sorting policy. If the priority of the sorting rule corresponding to the changed contact information is the lowest in the predefined sorting policy, all of the contacts are sorted again according to the sorting rule corresponding to the dynamic information, or only contacts adjacent to the contact whose dynamic information changes are sorted again according to the sorting rule corresponding to the dynamic information.

A last time sorted result may be cached in the mobile terminal. The last time sorted result may be updated intelligently according to the re-sorting operation, which saves computing time and resources of the mobile terminal. Accordingly, after the re-sorting operation, the mobile terminal updates the sorted result and displays the re-sorted contacts.

By way of non-limiting example, the sorting operation of this example is described with reference to Tables 1, 3, and 5. Table 1 is a static information summary table, Table 3 is a dynamic information table within one week, and Table 5 is an instant messaging information table.

In scenario 1, the user desires to find a contact through subscribed location information and name. The mobile terminal obtains subscribed location information and name information from Table 1, and sorts the contacts according to the sorting-by-subscribed location rule based on the subscribed location information (in a descending order of GUANGZHOU, SHENZHEN, BEIJING, and others). For example, contacts which have the same subscribed location with the user may rank in the first. For contacts with the same subscribed location obtained after the sorting operation according to the sorting-by-subscribed location rule (A1 and A3; A4, B2, B3 and C3; B1, C1 and C2; A2 and A5), a sorting operation is performed according to the sorting-by-name rule according to their name information. A sorted result is as shown in Table 6.

TABLE 6

| GUANGZHOU | SHENZHEN | BEIJING | Others |
|---|---|---|---|
| A1 | A4 | B1 | A2 |
| A3 | B2 | C1 | A5 |
| | B3 | C2 | |
| | C3 | | |

In scenario 2, the user desires to find a contact via operator and contact name. The mobile terminal obtains operator information and name information from Table 1, and sorts the contacts according to sorting-by-operator information rule based on the operator information (in a descending order of China Mobile, China Unicom, and China Telecommunications). For contacts of the same operator obtained after the sorting operation according to the sorting-by-operator information rule (A2, A3, A5, B2, C1 and C2; A1 and B1; A4, B3 and C3), a sorting operation is performed according to a sorting-by-name rule based on their name information. A sorted result is as shown in Table 7.

TABLE 7

| | China | China |
|---|---|---|
| China Mobile | Unicom | Telecommunications |
| A2 | A1 | A4 |
| A3 | B1 | B3 |
| A5 | | C3 |
| B2 | | |
| C1 | | |
| C2 | | |

In scenario 3, the user desires to find a contact via subscribed location and number range. The mobile terminal obtains subscribed location information and number range information from Table 1, and sorts the contacts according to the sorting-by-subscribed location information rule based on the subscribed location information first. For contacts having the same subscribed location after the sorting operation according to the sorting-by-subscribed location information rule, a sorting operation is performed according to the sorting-by-number range rule based on their number range information (in an ascending order of first three digits of their numbers). The sorted result is as shown in Table 8.

TABLE 8

| Name | Number Range | Subscribed Location |
|---|---|---|
| A1 | 130 | GUANGZHOU |
| A3 | 136 | GUANGZHOU |
| C3 | 133 | SHENZHEN |
| B3 | 133 | SHENZHEN |
| A4 | 133 | SHENZHEN |
| B2 | 136 | SHENZHEN |
| B1 | 130 | BEIJING |
| C1 | 139 | BEIJING |
| C2 | 159 | BEIJING |
| A5 | 136 | DALIAN |
| A2 | 159 | CHONGQING |

In addition, the user may further sort the contacts according to the sorting-by-name rule. For example, for contacts (C3, B3 and A3) with the same number range in Table 8, a sorting operation is performed according to the sorting-by-name rule based on their name information. A sorted result is as shown in Table 9.

TABLE 9

| Name | Number Range | Subscribed Location |
|---|---|---|
| A1 | 130 | GUANGZHOU |
| A3 | 136 | GUANGZHOU |
| A4 | 133 | SHENZHEN |
| B3 | 133 | SHENZHEN |
| C3 | 133 | SHENZHEN |
| B2 | 136 | SHENZHEN |
| B1 | 130 | BEIJING |
| C1 | 139 | BEIJING |
| C2 | 159 | BEIJING |
| A5 | 136 | DALIAN |
| A2 | 159 | CHONGQING |

In scenario 4, the user desires to find a contact via name of the contact and call duration. The mobile terminal obtains name information from Table 1 and obtains call duration information from Table 2 and sorts the contacts according to the sorting-by-name rule based on the name information, e.g., sorts the contacts according to the first Chinese character of their names. For contacts with the same first character obtained after the sorting operation according to the sorting-by-name rule (A1, A2, A3, A4 and A5; B1, B2 and B3; C1, C2 and C3), a sorting operation is performed according to the sorting-by-call duration rule based on their call duration information (in a descending order of the call durations). If the sorting is performed according to a descending order of the call durations, a sorted result is as shown in Table 10.

TABLE 10

| A | Call Duration | B | Call Duration | C | Call Duration |
|---|---|---|---|---|---|
| A1 | 2.6 | B3 | 6.5 | C3 | 1.5 |
| A5 | 1.5 | B2 | 0.9 | C1 | 0.5 |
| A4 | 1.1 | B1 | 0.8 | C2 | 0 |
| A2 | 0.5 | | | | |
| A3 | 0.3 | | | | |

In scenario 5, the user desires to find a contact via number of calls and name of the contact. The mobile terminal obtains the number of calls information from Table 2 and obtains name information from Table 1 and sorts the contacts according to the sorting-by-number of calls rule based on the number of calls information (e.g., in a descending order of the numbers of calls). For contacts with the same number of calls obtained after the sorting operation according to the sorting-by-number of calls rule (A2 and A3; A1 and A5; B3 and C1), a sorting operation is performed according to the sorting-by-name rule based on their name information. A sorted result is as shown in Table 11.

TABLE 11

| Name | Number of Calls |
|---|---|
| C3 | 14 |
| A4 | 13 |
| B2 | 10 |
| A2 | 8 |
| A3 | 8 |
| A1 | 7 |
| A5 | 7 |
| B1 | 5 |
| B3 | 4 |
| C1 | 4 |

In scenario 6, the user desires to find a contact via short message and subscribed location. The mobile terminal obtains short message information from Table 2 and obtains subscribed location information from Table 1 and sorts the contacts according to a sorting-by-short message information rule based on the short message information first. For contacts with the same number of short messages after the sorting operation according to the sorting-by-short message information rule (A4 and A5; C1 and C2), a sorting operation is performed according to the sorting-by-subscribed location information rule based on their subscribed location information. A sorted result is as shown in Table 12.

TABLE 12

| Name | Short Messages | Subscribed Location |
|---|---|---|
| A3 | 12 | GUANGZHOU |
| B2 | 8 | SHENZHEN |
| A2 | 7 | CHONGQING |
| C3 | 6 | SHENZHEN |
| B3 | 5 | SHENZHEN |
| A1 | 3 | GUANGZHOU |
| A4 | 2 | SHENZHEN |
| A5 | 2 | DALIAN |
| B1 | 1 | BEIJING |
| C1 | 0 | BEIJING |
| C2 | 0 | BEIJING |

In scenario 7, the user desires to find a contact via QQ contact group and name. The mobile terminal obtains QQ contact group information from Table 5 and obtains name information from Table 1 and sorts the contacts according to a sorting-by-QQ contact group information rule based on the QQ contact group information (in a descending order of schoolmates, friends, colleagues, others). For contacts with the same QQ contact group after the sorting operation according to the sorting-by-QQ contact group information rule (A1 and C3; A5, B3 and C2; A3, A4 and B1; A2, B2 and C1), a sorting operation is performed according to the sorting-by-name rule based on their name information. As sorted result is as shown in Table 13.

TABLE 13

| Schoolmates | Friends | Colleagues | Others |
|---|---|---|---|
| A1 | A5 | A3 | A2 |
| C3 | B3 | A4 | B2 |
| | C2 | B1 | C1 |

In scenario 8, the user desires to find a contact via name and recent focus times. The mobile terminal obtains name information from Table 1 and obtains recent focus times information from Table 5 and sorts the contacts according to the sorting-by-name rule based on the name information. For contacts with the same first letter after the sorting operation according to the sorting-by-name rule (A1, A2, A3, A4 and A5; B1, B2 and B3; C1, C2 and C3), a sorting operation is performed according to a sorting-by-recent focus times rule based on their recent focus times information (e.g., in a descending order of focus times). A sorted result is as shown in Table 14.

TABLE 14

| | Recent | | | | |
|---|---|---|---|---|---|
| A | Focus Times | B | Recent Focus Times | C | Recent Focus Times |
| A3 | 7 | B3 | 21 | C2 | 14 |
| A5 | 6 | B1 | 8 | C3 | 10 |
| A4 | 3 | B2 | 0 | C1 | 0 |
| A1 | 1 | | | | |
| A2 | 0 | | | | |

In various embodiments, a predefined sorting policy is obtained and contact information is obtained according to the sorting policy. The contacts are sorted according to the sorting policy based on the obtained contact information. Since the predefined sorting policy includes at least one of a static sorting rule and a dynamic sorting rule, it is possible to find a contact according to multiple sorting rules, which facilitates the user to find the contact rapidly, reduces time for finding the contact, increases the information processing performance of the mobile terminal, and increases the intelligence degree of the mobile terminal.

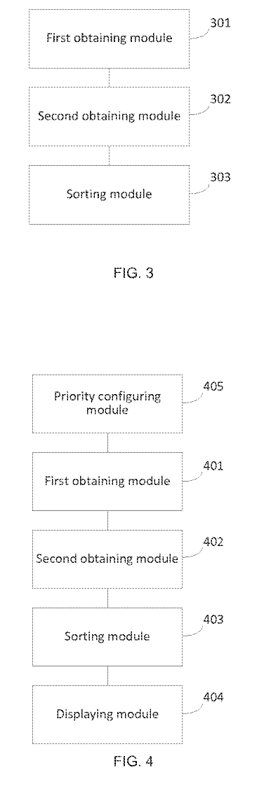

According to various embodiments, time is described as an apparatus for processing contacts. The apparatus is adapted to execute the method for processing contacts provided by examples 1 and 2. As shown in FIG. 3, the apparatus includes the following:
a first obtaining module 301, adapted to obtain a predefined sorting policy, wherein the predefined sorting policy includes at least one of a static sorting rule and a dynamic sorting rule;
a second obtaining module 302, adapted to obtain contact information according to the predefined sorting policy obtained by the first obtaining module 301, wherein the contact information includes dynamic information and/or static information; and
a sorting module 303, adapted to sort contacts according to the predefined sorting policy obtained by the first obtaining module 301 based on the contact information obtained by the second obtaining module 302.

In various embodiments, a predefined sorting policy is obtained and contact information is obtained according to the sorting policy. The contacts are sorted according to the sorting policy based on the obtained contact information. Since the predefined sorting policy includes at least one of a static sorting rule and a dynamic sorting rule, it is possible to find a contact according to multiple sorting rules, which facilitates the user to find the contact rapidly, reduces time for finding the contact, increases the information processing performance of the mobile terminal, and increases the intelligence degree of the mobile terminal.

An apparatus for processing contacts is described according to various embodiments. The apparatus is adapted to execute the method for processing contacts provided by examples 1 and 2. As shown in FIG. 4, the apparatus includes the following:
a first obtaining module 401, adapted to obtain a predefined sorting policy, wherein the predefined sorting policy includes at least one of a static sorting rule and a dynamic sorting rule;
a second obtaining module 402, adapted to obtain contact information according to the predefined sorting policy obtained by the first obtaining module 401, wherein the contact information includes dynamic information and/or static information; and
a sorting module 403, adapted to sort contacts according to the predefined sorting policy obtained by the first obtaining module 401 based on the contact information obtained by the second obtaining module 402.

The static sorting rule includes at least one of the following: a sorting-by-name rule, a sorting-by-number rule, a sorting-by-subscribed location rule, a sorting-by-operator rule, a sorting-by-contact relationship rule, and a sorting-by-mailbox rule. The dynamic sorting rule includes at least one of the following: a sorting-by-communication time rule, a sorting-by-communication frequency rule, a sorting-by-communication duration rule, and a sorting-by-IM focus degree rule. The sorting-by-communication frequency rule may include a sorting-by-outgoing times rule, a sorting-by-incoming times rule, a sorting-by-number of calls rule, a sorting-by-number of short messages rule, and a sorting-by-communication times rule.

The second obtaining module 402 includes the following:
a dynamic table maintaining unit, adapted to create a dynamic information table, and update dynamic information of contacts in the dynamic information table in real time; and a dynamic information obtaining unit, adapted to obtain the dynamic information of the contacts from the dynamic information table.
   The dynamic information of the contact includes at least one of: number of calls, call duration, number of short messages, instant messaging focus times, and number of mails, etc.

In one application of the various embodiments, the second obtaining module 402 further includes a first static information obtaining unit, adapted to obtain static information of the contacts from a local address book according to the predefined sorting policy.

In another application of the various embodiments, the second obtaining module 402 may include the following:
a static table maintaining unit, adapted to create a static information table and update the static information of the contacts in the static information table in real time; and
a second static information obtaining unit, adapted to obtain the static information of the contacts from the static information table according to the static sorting rule.
   The static information of the contact includes at least one of: name, number, number subscribed location, operator that the number belongs to, contact group, mailbox, instant messaging account, etc.

According to various embodiments, the apparatus further includes the following:
a priority configuring module 405, adapted to respectively configure if the predefined sorting policy includes at least two kinds of sorting rules and a priority for each sorting rule;
the sorting module 403 is adapted to determine an applying order of the sorting rules according to a descending order of the priorities, and perform the sorting operation to the contacts according to the sorting rules in turn; wherein a sorted result is obtained after the contacts are sorted according to a prior sorting rule, and the sorted result is sorted according to a posterior sorting rule.

According to various embodiments, the apparatus further includes a displaying module 404, adapted to display the contacts sorted by the sorting module 403. The sorting module 403 is further adapted to sort the contacts again according to the predefined sorting policy if the contact information obtained by the second obtaining module 402 changes; the displaying module 404 is further adapted to display the contact re-sorted by the sorting module 403.

Generally, a last time sorted result is cached in the mobile terminal. The last time sorted result may be updated intelligently according to the re-sorting operation, which saves computing time and resources of the mobile terminal.

In various embodiments, a predefined sorting policy is obtained and contact information is obtained according to the sorting policy. The contacts are sorted according to the sorting policy based on the obtained contact information. Since the predefined sorting policy includes at least one of a static sorting rule and a dynamic sorting rule, it is possible to find a contact according to multiple sorting rules, which facilitates the user to find the contact rapidly, reduces time for finding the contact, increases the information processing performance of the mobile terminal. and increases the intelligence degree of the mobile terminal.

A mobile terminal which includes the apparatus provided by the various examples described above is described according to various embodiments.

The mobile terminal is a mobile computer device and includes, but is not limited to, cell phone, laptop computer, palmtop computer, onboard computer, etc. The type of the mobile terminal is not restricted in the present disclosure. In the apparatus for processing contacts provided by the various embodiments, descriptions are given by dividing the apparatus into several functional modules. In a practical application, the functions may be executed by different functional modules according to a practical requirement, e.g., the apparatus is divided into different functional modules to implement all or part of the functions described above. In addition, the mobile terminal and apparatus for processing contacts in the above examples have the same idea with the above method examples. Detailed implementation may be seen from the method examples, and will not be repeated herein.

Those with ordinary skill in the art would know that all or some of the blocks of the present disclosure may be implemented by hardware, or implemented by a program executed on a relevant hardware. The program may be stored on a computer readable storage medium. The storage medium may be a read only memory, a disk or a compact disk.

What has been described and illustrated herein are various embodiments of the disclosure along with variations. Many variations are possible within the scope of the disclosure, which is intended to be defined by the following claims, and their equivalents, in which all terms are meant in their broadest reasonable sense unless otherwise indicated.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for processing contacts, comprising:
obtaining a predefined sorting policy, wherein the predefined sorting policy comprises at least two sorting rules; each one of at least two sorting rules is a static sorting rule or a dynamic sorting rule and is configured with a priority;
obtaining contact information according to the predefined sorting policy, wherein the contact information includes dynamic information and/or static information; and
determining an applying order of the at least two sorting rules in a descending order of priorities of the at least two sorting rules;
sorting the contacts according to the at least two sorting rules in turn based on the obtained contact information;
wherein a sorted result is obtained after the contacts are sorted according to a prior sorting rule of the at least two sorting rules, and the sorted result is sorted according to a posterior sorting rule of the at least two sorting rules.

2. The method of claim 1, wherein the static sorting rule comprises at least one of:
a sorting-by-name rule, a sorting-by-number rule, a sorting-by-subscribed location rule, a sorting-by-operator rule, a sorting-by-contact relationship rule, and a sorting-by-mailbox rule; and
the dynamic sorting rule comprises at least one of:
a sorting-by-communication time rule, a sorting-by-communication frequency rule, a sorting-by-communication duration rule, a sorting-by-instant messaging focus degree rule, and a sorting-by-weighted dynamic information rule.

3. The method of claim 2, wherein the obtaining contact information according to the predefined sorting policy comprises:
creating a dynamic information table, and updating the dynamic information of contacts in the dynamic information table in real time; and
obtaining the dynamic information of the contacts from the dynamic information table according to the dynamic sorting rule;
wherein the dynamic information of the contact comprises at least one of: number of calls, call duration, number of short messages, instant messaging times, and number of mails.

4. The method of claim 2, wherein the obtaining contact information according to the predefined sorting policy comprises:
obtaining static information of the contacts from a local address book according to the predefined sorting policy; or
creating a static information table, updating the static information of the contacts in the static information table in real time, and obtaining the static information of the contacts from the static information table according to the static sorting rule;
the static information of the contacts comprises at least one of: name, number, number subscribed location, operator that the number belongs to, contact relationship group.

5. The method of claim 1, further comprising:
after sorting the contacts according to the predefined sorting policy based on the contact information,
displaying the sorted contacts.

6. The method of claim 1, further comprising:
if the contact information changes, sorting the contacts according to the predefined sorting policy again.

7. An apparatus for processing contacts, comprising:
one or more processors;
a memory; and
one or more program modules stored in the memory and to be executed by the one or more processors, the one or more program modules comprise:
a first obtaining module, adapted to obtain a predefined sorting policy, wherein the predefined sorting policy comprises at least two sorting rules, each one of the at least sorting rules is a static sorting rule or a dynamic sorting rule;
a priority configuring module, adapted to respectively configure a priority for each of the at least two sorting rules;
a second obtaining module, adapted to obtain contact information according to the predefined sorting policy obtained by the first obtaining module, wherein the contact information comprises dynamic information and/or static information; and
a sorting module, adapted to determine an applying order of the at least two sorting rules according to a descending order of priorities of the at least two sorting rules, sort contacts according to the at least two sorting rules obtained by the first obtaining module in turn based on the contact information obtained by the second obtaining module;
wherein a sorted result is obtained after the contacts are sorted according to a prior sorting rule of the at least two sorting rules, and the sorted result is sorted according to a posterior sorting rule of the at least two sorting rules.

8. The apparatus of claim 7, wherein the static sorting rule comprises at least one of:
a sorting-by-name rule, a sorting-by-number rule, a sorting-by-subscribed location rule, a sorting-by-operator rule, a sorting-by-contact relationship rule, and a sorting-by-mailbox rule; and
the dynamic sorting rule comprises at least one of:
a sorting-by-communication time rule, a sorting-by-communication frequency rule, a sorting-by-communication duration rule, and a sorting-by-instant messaging focus degree rule.

9. The apparatus of claim 8, wherein the second obtaining module comprises:
a dynamic table maintaining unit, adapted to create a dynamic information table, and update the dynamic information of contacts in the dynamic information table in real time; and
a dynamic information obtaining unit, adapted to obtain the dynamic information of the contacts from the dynamic information table;
wherein dynamic information of the contact comprises at least one of: number of calls, call duration, number of short messages, instant messaging times, and number of mails.

10. The apparatus of claim 8, wherein the second obtaining module comprises:
a first static information obtaining unit, adapted to obtain the static information of the contacts from a local address book according to the predefined sorting policy;
a static table maintaining unit, adapted to create a static information table, and update the static information of the contacts in the static information table in real time; and
a second static information obtaining unit, adapted to obtain the static information of the contacts from the static information table according to the static sorting rule;
wherein the static information of the contact comprises at least one of: name, number, number subscribed location, operator that the number belongs to, and contact relationship group.

11. The apparatus of claim 7, further comprising:
a displaying module, adapted to display the contacts sorted by the sorting module.

12. The apparatus of claim 7, wherein the sorting module is further adapted to sort the contacts again according to the predefined sorting policy if the contact information obtained by the second obtaining module changes.

13. A mobile terminal, comprising an apparatus for processing contacts; wherein the apparatus comprises:
one or more processors;
a memory; and
one or more program modules stored in the memory and to be executed by the one or more processors, the one or more program modules comprise:
a first obtaining module, adapted to obtain a predefined sorting policy, wherein the predefined sorting policy comprises at least two sorting rules, each one of the at least sorting rules is a static sorting rule or a dynamic sorting rule;
a priority configuring module, adapted to respectively configure a priority for each of the at least two sorting rules;
a second obtaining module, adapted to obtain contact information according to the predefined sorting policy obtained by the first obtaining module, wherein the contact information comprises dynamic information and/or static information; and
a sorting module, adapted to determine an applying order of the at least two sorting rules according to a descending order of priorities of the at least two sorting rules, sort contacts according to the at least two sorting rules obtained by the first obtaining module in turn based on the contact information obtained by the second obtaining module;
wherein a sorted result is obtained after the contacts are sorted according to a prior sorting rule of the at least two sorting rules, and the sorted result is sorted according to a posterior sorting rule of the at least two sorting rules.

14. The mobile terminal of claim 13, wherein the static sorting rule comprises at least one of:
a sorting-by-name rule, a sorting-by-number rule, a sorting-by-subscribed location rule, a sorting-by-operator rule, a sorting-by-contact relationship rule, and a sorting-by-mailbox rule; and
the dynamic sorting rule comprises at least one of:
a sorting-by-communication time rule, a sorting-by-communication frequency rule, a sorting-by-communication duration rule, and a sorting-by-instant messaging focus degree rule.

15. The mobile terminal of claim 14, wherein the second obtaining module comprises:
a dynamic table maintaining unit, adapted to create a dynamic information table, and update the dynamic information of contacts in the dynamic information table in real time; and
a dynamic information obtaining unit, adapted to obtain the dynamic information of the contacts from the dynamic information table;
wherein dynamic information of the contact comprises at least one of: number of calls, call duration, number of short messages, instant messaging times, and number of mails.

16. The mobile terminal of claim 14, wherein the second obtaining module comprises:
a first static information obtaining unit, adapted to obtain the static information of the contacts from a local address book according to the predefined sorting policy;
a static table maintaining unit, adapted to create a static information table, and update the static information of the contacts in the static information table in real time; and
a second static information obtaining unit, adapted to obtain the static information of the contacts from the static information table according to the static sorting rule;
wherein the static information of the contact comprises at least one of: name, number, number subscribed location, operator that the number belongs to, and contact relationship group.

17. The mobile terminal of claim 13, further comprising:
a displaying module, adapted to display the contacts sorted by the sorting module.

18. The mobile terminal of claim 13, wherein the sorting module is further adapted to sort the contacts again according to the predefined sorting policy if the contact information obtained by the second obtaining module changes.
